(19) United States
(12) Patent Application Publication
(10) Pub. No.: US 2015/0219871 A1
(43) Pub. Date: Aug. 6, 2015

(54) LENS MODULE

(71) Applicant: SAMSUNG ELECTRO-MECHANICS CO., LTD., Suwon-Si (KR)

(72) Inventor: Duck Hun KIM, Suwon-Si (KR)

(73) Assignee: SAMSUNG ELECTRO-MECHANICS CO., LTD., Suwon-Si (KR)

(21) Appl. No.: 14/255,816

(22) Filed: Apr. 17, 2014

(30) Foreign Application Priority Data
Feb. 5, 2014 (KR) 10-2014-0012856

(51) Int. Cl. G02B 7/02; G02B 13/00

(52) U.S. Cl. CPC G02B 7/021; G02B 13/001

(57) ABSTRACT

There is provided a lens module including: a first lens having a first coupling portion; a second lens having a second coupling portion; and a space maintaining member disposed between the first and second lenses and having third and fourth coupling portions coupled to the first and second coupling portions, respectively.

### CROSS-REFERENCE TO RELATED APPLICATION

This application claims the benefit of Korean Patent Application No. 10-2014-0012856 filed on Feb. 5, 2014, with the Korean Intellectual Property Office, the disclosure of which is incorporated herein in its entirety by reference.

### BACKGROUND

The present technology generally relates to a lens module including a space maintaining member.

As overall performance of portable electronic devices (for example, mobile phones) has improved, small camera modules mounted in such portable devices have been required to have high resolutions. Therefore, such small camera modules have gradually come to be configured of lens modules including increasing numbers of lenses.

Lens modules including increasing numbers of lenses may include lenses and a lens barrel accommodating the lenses therein. Such lens modules have a structure in which the lenses are sequentially inserted into the lens barrel to allow optical axes of the lenses to coincide with each other.

However, since the optical axes of the lenses are aligned with each other by the lens barrel in the above-mentioned structure, the lenses mounted in the lens barrel must be manufactured to have the same size or the same degree of machining errors, which may be problematic.

In addition, in the above-mentioned structure, respective lenses may be inserted into the lens barrel in a press-fitting scheme, such that coupling between the lens barrel and the lenses may be difficult to implement. Therefore, the development of a lens module having a structure in which coupling between lenses is facilitated has been demanded.

Further, in the lens modules including increased numbers of lenses, a flare phenomenon occurring due to internal reflection may relatively easily occur, such that lens resolution may be decreased. Therefore, the development of a lens module capable of enabling the accurate alignment of lenses and decreasing a flare phenomenon has also been demanded.

For reference, as the related art associated with the present disclosure, there are provided Patent Documents 1 to 3.

### SUMMARY

Some embodiments of the present disclosure may provide a lens module allowing lenses to be easily aligned and a flare phenomenon to be decreased.

According to some embodiments of the present disclosure, a lens module may include: a first lens having a first coupling portion; a second lens having a second coupling portion; and a space maintaining member disposed between the first and second lenses and having third and fourth coupling portions coupled to the first and second coupling portions, respectively.

The first coupling portion may have a conical sectional surface having a first angle, inclined with respect to an optical axis, and the third coupling portion may have a conical sectional surface having a third angle, inclined with respect to the optical axis.

The first and third inclined angles may be the same as or different from each other.

The second coupling portion may have a conical sectional surface having a second angle, inclined with respect to an optical axis, and the fourth coupling portion may have a conical sectional surface having a fourth angle, inclined with respect to the optical axis.

The second and fourth inclined angles may be the same as or different from each other.

The first coupling portion may be a hemispherical groove having a first radius, and the third coupling portion may be a hemispherical groove having a third radius.

The first and third radii may be the same as or different from each other.

The second coupling portion may be a hemispherical groove having a second radius, and the fourth coupling portion may be a hemispherical groove having a fourth radius.

The second and fourth radii may be the same as or different from each other.

An inner peripheral surface of the space maintaining member may be formed as a conical sectional surface having an inclined angle with respect to an optical axis.

An inner peripheral surface of the space maintaining member may be formed of a plurality of conical sectional surfaces having different inclined angles with respect to an optical axis.

The space maintaining member may be formed of a plurality of members including holes having different sizes.

The space maintaining member may include: a first space maintaining member including a first hole having a minimum diameter corresponding to a first size and a first inner peripheral surface having a first angle, inclined with respect to an optical axis; and a second space maintaining member including a second hole having a minimum diameter corresponding to a second size and a second inner peripheral surface having a second angle, inclined with respect to the optical axis.

The first and second sizes maybe the same as or different from each other.

The first and second inclined angles may be the same as or different from each other.

According to some embodiments of the present disclosure, a lens module may include: a lens barrel having a lens accommodating portion formed therein; a first lens mounted in the lens accommodating portion so as to be spaced apart from a side of the lens accommodating portion and having a first coupling portion; a second lens having a second coupling portion; and a space maintaining member disposed between the first and second lenses and having third and fourth coupling portions coupled to the first and second coupling portions, respectively.

The second lens may be coupled to the lens barrel.

The space maintaining member may be mounted in the lens accommodating portion so as to be spaced apart from the side of the lens accommodating portion.

The lens accommodating portion may have one or more grooves formed in the side thereof, and the second lens may have protrusions formed so as to be coupled to the grooves, the number of protrusions being the same as that of grooves.

The lens module may further include a press-fitting member fixing the second lens to the lens barrel so as to prevent the second lens from being separated from the lens barrel.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a lens module according to an exemplary embodiment;

FIG. 2 is an enlarged view of portion A shown in FIG. 1;

FIG. 3 is an enlarged view of portion B shown in FIG. 1;

FIG. 4 is a cross-sectional view of a lens module according to another exemplary embodiment;

FIG. 5 is an enlarged view of portion A shown in FIG. 4;

FIG. 6 is an enlarged view of portion B shown in FIG. 4;

FIG. 7 is a cross-sectional view of a lens module according to another exemplary embodiment of the present disclosure;

FIG. 8 is an enlarged view of portion A shown in FIG. 7;

FIG. 9 is an enlarged view of portion B shown in FIG. 7;

FIG. 10 is a cross-sectional view of a lens module according to another exemplary embodiment;

FIG. 11 is a cross-sectional view of a lens module according to another exemplary embodiment; and

FIG. 12 is a bottom view of a lens module according to another exemplary embodiment.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

For reference, it is to be noted that first to fifth lenses to be described below are named based on a sequence of lenses close to a subject. Therefore, in the following description, first and second lenses may not correspond to first and second lenses mentioned in the claims. For example, fourth and fifth lenses to be described below may correspond to first and second lenses mentioned in the claims.

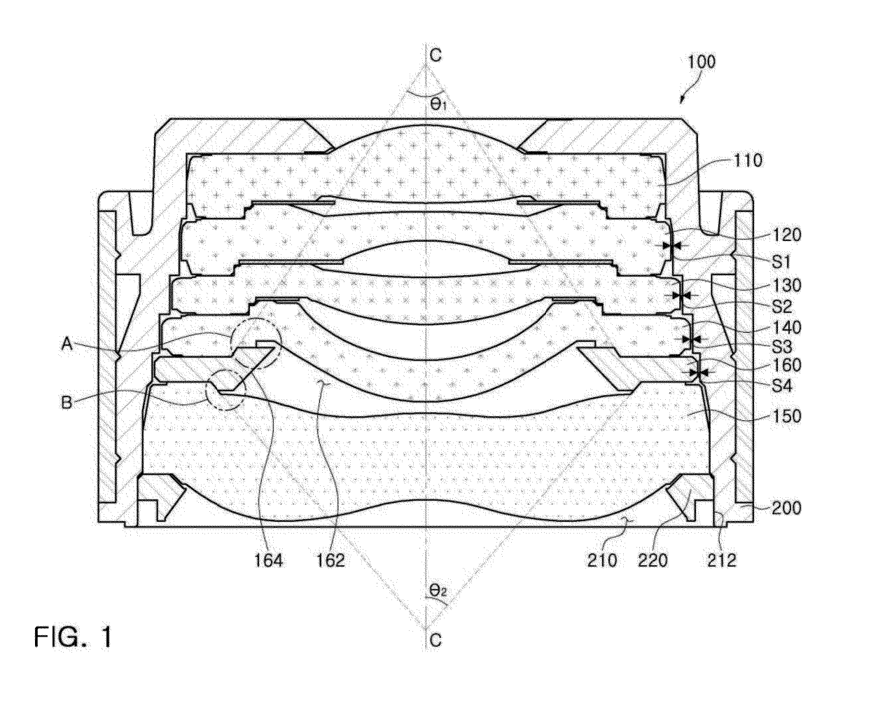

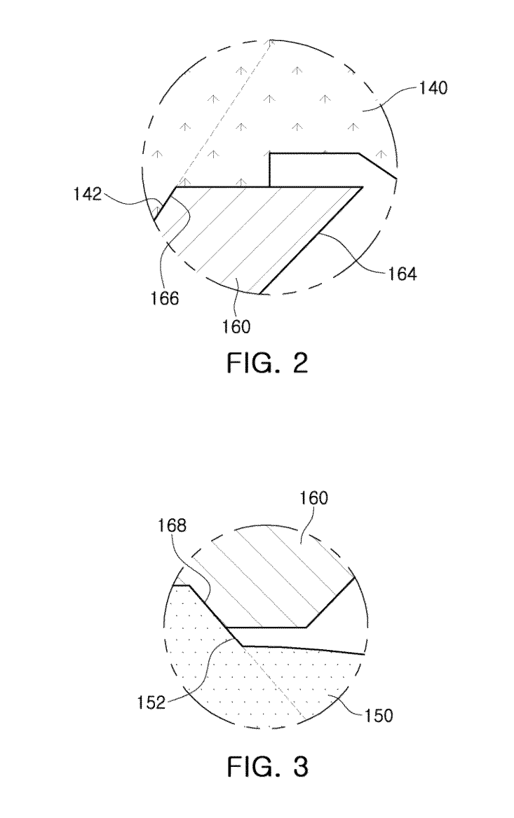

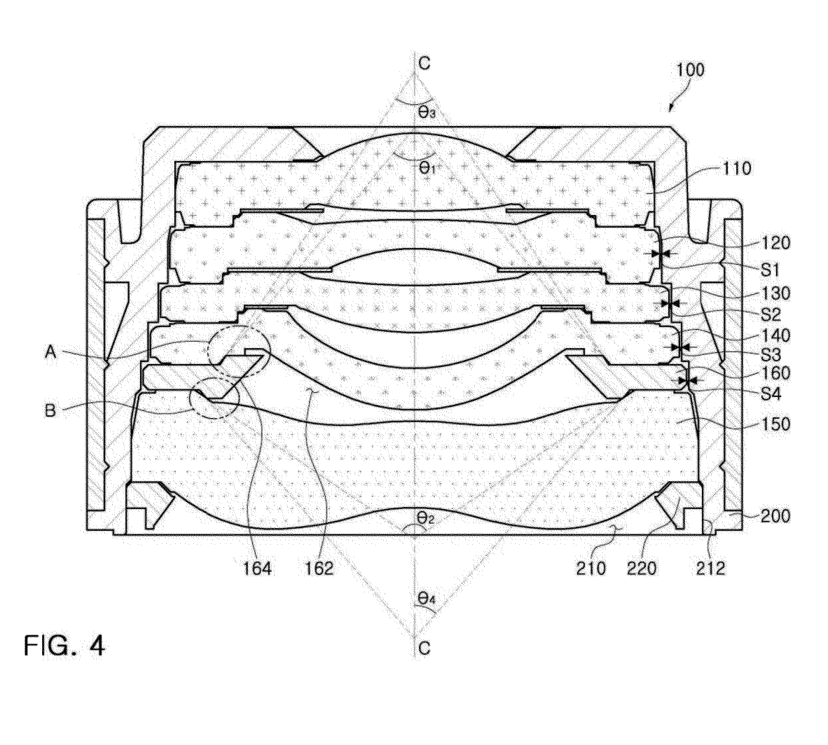

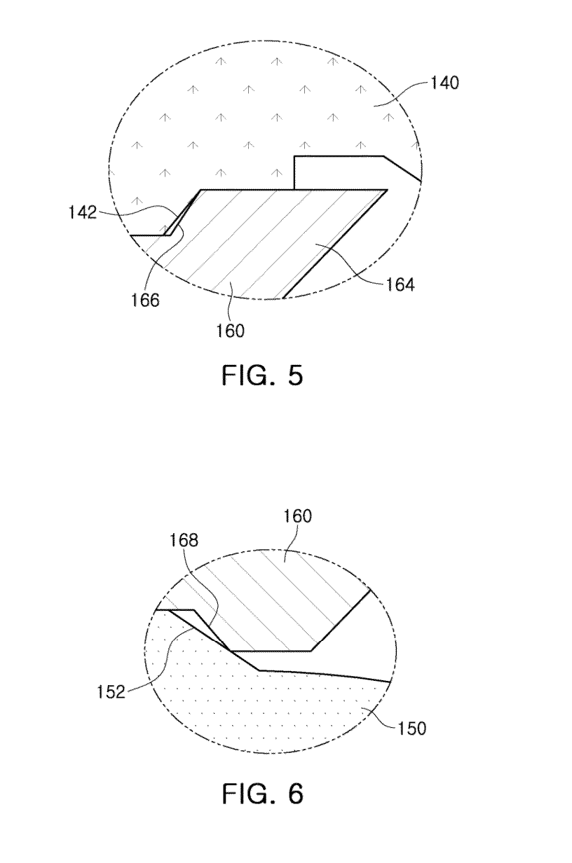

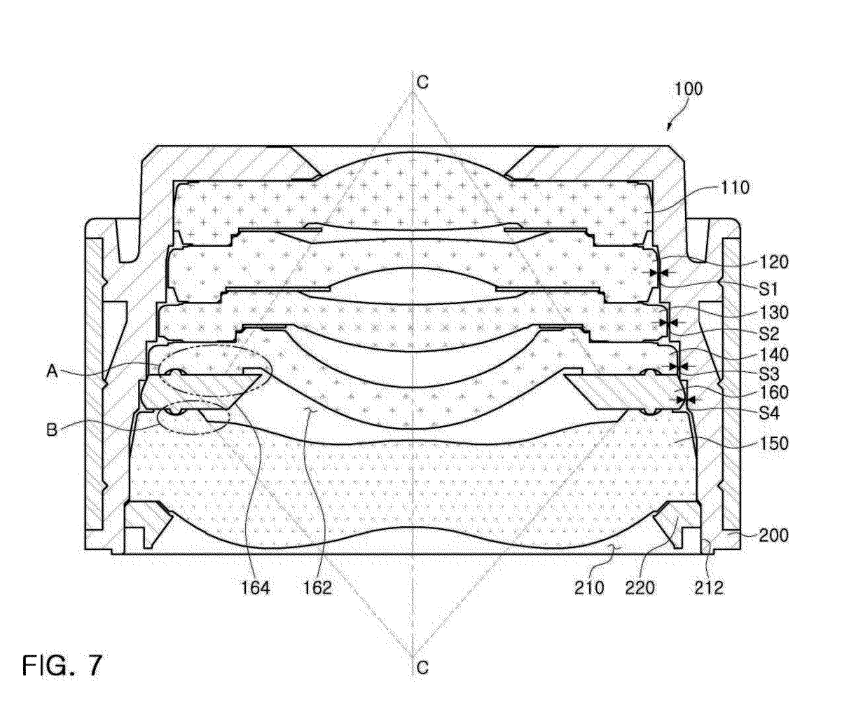

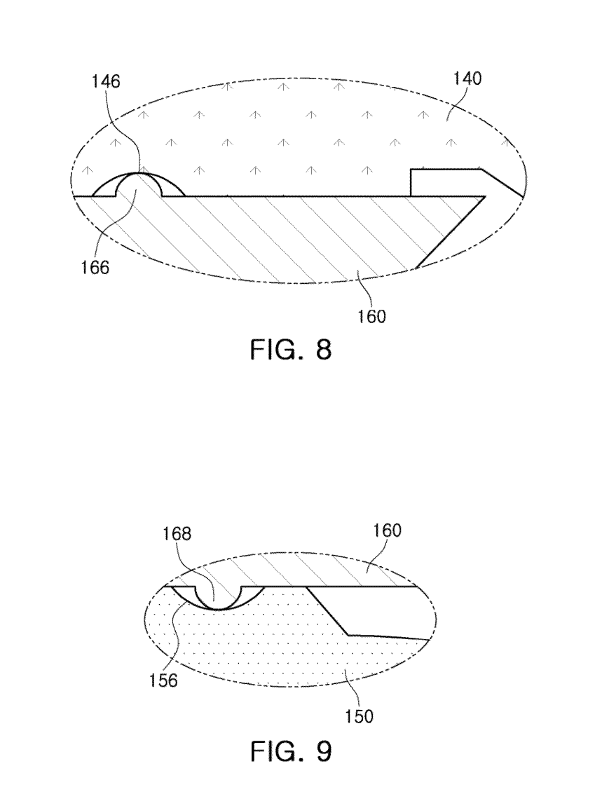

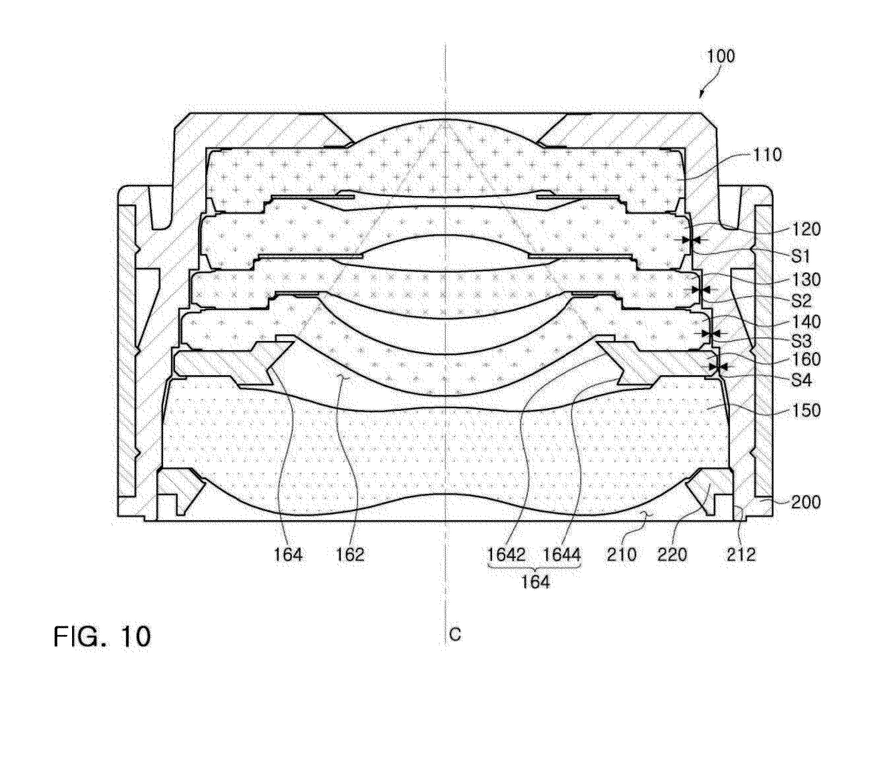

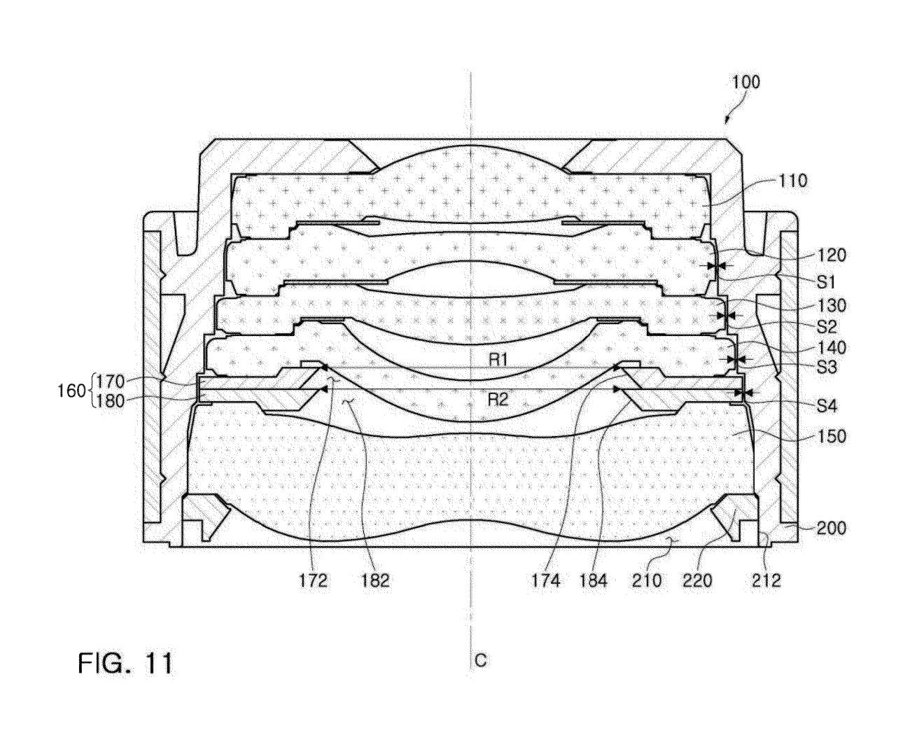

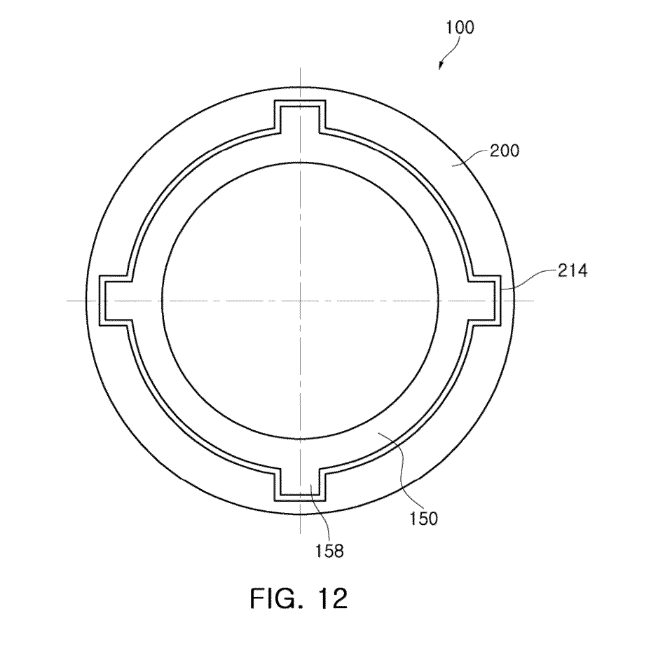

FIG. 1 is a cross-sectional view of a lens module according to an exemplary embodiment of the present disclosure; FIG. 2 is an enlarged view of portion A shown in FIG. 1; FIG. 3 is an enlarged view of portion B shown in FIG. 1; FIG. 4 is a cross-sectional view of a lens module according to another exemplary embodiment of the present disclosure; FIG. 5 is an enlarged view of portion A shown in FIG. 4; FIG. 6 is an enlarged view of portion B shown in FIG. 4; FIG. 7 is a cross-sectional view of a lens module according to another exemplary embodiment of the present disclosure; FIG. 8 is an enlarged view of portion A shown in FIG. 7; FIG. 9 is an enlarged view of portion B shown in FIG. 7; FIG. 10 is a cross-sectional view of a lens module according to another exemplary embodiment of the present disclosure; FIG. 11 is a cross-sectional view of a lens module according to another exemplary embodiment of the present disclosure; and FIG. 12 is a bottom view of a lens module according to another exemplary embodiment of the present disclosure.

A lens module according to an exemplary embodiment of the present disclosure will be described with reference to FIGS. 1 through 3.

The lens module 100 may include a plurality of lenses. For example, the lens module 100 may include a first lens 110, a second lens 120, a third lens 130, a fourth lens 140, and a fifth lens 150. However, the lens module 100 is not limited to including five lenses. For example, the lens module 100 may include four or less lenses or include sixth or more lenses. As an example, the lens module 100 may also include three lenses.

The lens module 100 may include a space maintaining member 160. For example, the lens module 100 may include the space maintaining member 160 constantly maintaining a space between the fourth lens 140 and the fifth lens 150. However, the space maintaining member 160 is not limited to being formed between the four lens 140 and the fifth lens 150. For example, the space maintaining member 160 may be formed between the third lens 130 and the fourth lens 140, if necessary, or may also be formed at other positions. In addition, the number of space maintaining members 160 is not limited to being singular. For example, the number of space maintaining members 160 may be plural. In this case, the space maintaining members 160 may be formed between the second lens 120 and the third lens 130 and between the fourth lens 140 and the fifth lens 150, respectively. Alternatively, the plurality of space maintaining members 160 may be formed integrally with each other so that a space between the fourth lens 140 and the fifth lens 150 are sufficiently maintained.

The lens module 100 may include a lens barrel 200. For example, the lens module 100 may include the lens barrel 200 accommodating all of the plurality of lenses 110, 120, 130, 140, and 150 and the space maintaining member 160 therein. For example, the lens module 100 may include the lens barrel 200 having a lens accommodating portion 210 formed therein.

The lens barrel 200 may include the lens accommodating portion 210 capable of accommodating the plurality of lenses therein. For example, the lens accommodating portion 210 may have a depth enough to accommodate all of the plurality of lenses 110 to 150 therein. The lens accommodating portion 210 may have a stair shaped cross section. For example, the cross-sectional size of the lens accommodating portion 210 may be extended so as to be same as or similar to those of the first to fifth lenses 110 to 150. As an example, the uppermost portion of the lens accommodating portion 210 (based on an optical axis (C-C) of FIG. 1) may have substantially the same cross-sectional size of that of the first lens 110, and the lowermost portion (based on the optical axis (C-C) of FIG. 1) of the lens accommodating portion 210 may have substantially the same cross-sectional size of that of the fifth lens 150. However, the cross-sectional size of the lens accommodating portion 210 does not necessarily coincide with those of the lenses 120, 130, and 140. For example, a portion of the lens accommodating portion 210 may be larger than the cross-sectional sizes of the second to fourth lenses 120 to 140. As an example, a first space S1 may be formed between an inner surface 212 of the lens accommodating portion 210 and the second lens 120, a second space S2 may be formed between the inner surface 212 of the lens accommodating portion 210 and the third lens 130, a third space S3 may be formed between the inner surface 212 of the lens accommodating portion 210 and the fourth lens 140, and a fourth space S4 may be formed between the inner surface 212 of the lens accommodating portion 210 and the space maintaining member 160. For reference, all of the spaces S1 to S4 may be the same as or different from each other.

The lens module 100 may include a press-fitting member 220. For example, the lens module 100 may include a press-fitting member 220 preventing separation of the lenses 110 to 150 accommodated in the lens barrel 200. The press-fitting member 220 may have a substantially ring shape. For example, the press-fitting member 220 may have the ring shape extended along an edge of the fifth lens 150. The press-fitting member 220 may be fixed to the lens barrel 200. For example, the press-fitting member 220 may be fitted into the lens accommodating portion 210 of the lens barrel 200 in a press-fitting scheme. Alternatively, the press-fitting member 220 may be firmly adhered to the lens barrel 200 by an adhesive, or the like.

Meanwhile, in the above-mentioned configuration, the fourth lens 140 and the fifth lens 150 may be coupled to the space maintaining member 160. In addition, the fourth lens 140 and the fifth lens 150 may be aligned by the space maintaining member 160. The above configuration will be described with reference to FIGS. 2 and 3.

The fourth lens 140 may include a first coupling portion 142 coupled to the space maintaining member 160. For example, the fourth lens 140 may have a first conical sectional surface 142 formed on one surface thereof, wherein the first conical sectional surface 142 has an inclined angle θ1 with respect to the optical axis C-C. Similarly, the fifth lens 150 may include a second coupling portion 152 coupled to the space maintaining member 160. For example, the fifth lens 150 may have a second conical sectional surface 152 formed on one surface thereof, wherein the second conical sectional surface 152 has an inclined angle θ2 with respect to the optical axis C-C. The first inclined angle θ 1 and the second inclined angle θ 2 may be different from each other.

The space maintaining member 160 may include third and fourth coupling portions 166 and 168 coupled to the fourth and fifth lenses 140 and 150, respectively. For example, the space maintaining member 160 may have a third conical sectional surface 166 formed on one surface thereof, wherein the third conical sectional surface 166 has an inclined angle θ1 that is substantially the same as or similar to that of the first conical sectional surface 142. In addition, the space maintaining member 160 may have a fourth conical sectional surface 168 formed on the other surface thereof, wherein the fourth conical sectional surface 168 has an inclined angle θ2 that is substantially the same as or similar to that of the second conical sectional surface 152.

Since the fourth lens 140 and the fifth lens 150 configured as described above may contact the space maintaining members 160 by the coupling portions 142, 152, 166, and 168 having a conical sectional surface shape, they may be easily coupled to and aligned by the space maintaining member 160.

Meanwhile, the space maintaining member may suppress a flare phenomenon. For example, an inner peripheral surface 164 of a hole 162 formed in the space maintaining member 160 may have a predetermined angle, inclined with respect to the optical axis C-C. For example, the inner peripheral surface 164 may be gradually extended from the first lens 110 toward the fifth lens 150. This shape may be advantageous for effectively suppressing a flare phenomenon due to internal reflection of the lens without hindering incidence of effective light.

Another form of a lens module will be described. For reference, in the following description, the same components as those of the lens module according to an exemplary embodiment of the present disclosure described above will be denoted by the same reference numerals and a description thereof will be omitted.

A lens module according to another exemplary embodiment of the present disclosure will be described with reference to FIGS. 4 through 6.

A lens module 100 according to the present exemplary embodiment may be different in a coupled structure between fourth and fifth lenses 140 and 150 and a space maintaining structure from the lens module according to an exemplary embodiment of the present disclosure described above. For example, a first inclined angle θ1 of a first conical sectional surface 142 formed on one surface of the fourth lens 140 may be different from a third inclined angle θ3 of a third conical sectional surface 166 formed on one surface of the space maintaining member 160. In addition, a second inclined angle θ2 of a second conical sectional surface 152 formed on one surface of the fifth lens 150 may be different from a fourth inclined angle θ4 of a fourth conical sectional surface 168 formed on the other surface of the space maintaining member 160.

In the lens module 100 configured as described above, the fourth lens 140 and the fifth lens 150 may be coupled to the space maintaining member 160 in a line contact form, such that a manufacturing tolerance of the lenses 140 and 150 and the space maintaining member 160 may be decreased.

Next, a lens module according to another exemplary embodiment of the present disclosure will be described with reference to FIGS. 7 through 9.

A lens module 100 according to the present exemplary embodiment may be different in a coupled structure between fourth and fifth lenses 140 and 150 and a space maintaining structure from the lens module according to an exemplary embodiment of the present disclosure described above. For example, the fourth lens 140 may have first grooves 146 formed in one surface thereof and having a substantially hemispherical shape, and the fifth lens 150 may have second grooves 156 formed in one surface thereof and having a substantially hemispherical shape. In addition, the space maintaining member 160 may have first and second protrusions 166 and 168 formed on one surface and the other surface thereof, wherein the first protrusions are fitted into the first grooves 146 and have a substantially hemispherical shape, and the second protrusions are fitted into the second groove 156 and have a substantially hemispherical shape.

The first and second grooves 146 and 156 may have curvature characteristics that are the same as or different from those of the first and second protrusions 166 and 168, respectively. For example, the number of first grooves 146 may be the same as or larger than that of first protrusion 166, and the number of second grooves 156 may be the same as or larger than that of the second protrusions 168.

The fourth and fifth lenses 140 and 150 configured as described above may be coupled to the space maintaining member 160 by a plurality of protrusions and grooves, which may be advantageous for improving coupling force between the fourth and fifth lenses 140 and 150 and the space maintaining member 160 and improve reliability in aligning positions of the fourth and fifth lenses 140 and 150.

Next, a lens module according to another exemplary embodiment of the present disclosure will be described with reference to FIGS. 10 and 11.

The lens module 100 according to the present exemplary embodiment may be different in a shape of a space maintaining member 160 from the lens module according to exemplary embodiments of the present disclosure described above. For example, the space maintaining member 160 may suppress a flare phenomenon due to internal reflection of a lens.

As an example, an inner peripheral surface 164 of the space maintaining member 160 may be formed of a plurality of inclined surfaces 1642 and 1644. For example, a first inner peripheral surface 1642 of the space maintaining member 160 may have a first inclined angle, and a second inner peripheral surface 1644 thereof may have a second inclined angle. In addition, the first and second inner peripheral surfaces 1642 and 1644 may form a substantially acute angle. However, the first and second inner peripheral surfaces 1642 and 1644 do not necessarily form the acute angle. For example, the first and second inner peripheral surfaces 1642 and 1644 may form an obtuse angle.

As another example, the number of space maintaining members 160 may be plural. For example, the space maintaining member 160 may include a first space maintaining member 170 and a second space maintaining member 180. However, the number of space maintaining members 160 is not limited to 2. For example, the number of space maintaining members 160 may be three or more.

The first space maintaining member 170 may have a first hole 172 formed therein, wherein the first hole 172 has a minimum diameter of R1. In addition, the first space maintaining member 170 may have a first inner peripheral surface 174 having a first inclined angle. For example, the first inner peripheral surface 174 may have an inclined angle gradually extended from the first lens 110 toward the fifth lens 150.

The second space maintaining member 180 may have a second hole 182 formed therein, wherein the second hole 182 has a minimum diameter of R2. In addition, the second space maintaining member 180 may have a second inner peripheral surface 184 having a second inclined angle. For example, the second inner peripheral surface 184 may have an inclined angle gradually extended from the first lens 110 toward the fifth lens 150.

The first and second holes 172 and 182 may have sizes that are the same as or different from each other. For example, the first hole 172 may be smaller than the second hole 182. However, the first hole 172 is not necessarily smaller than the second hole 182. For example, the first hole 172 may also be larger than the second hole 182.

The first and second inner peripheral surfaces 174 and 184 may have sizes that are the same as or different from each other. For example, an inclined angle of the first inner peripheral surface 174 may be larger than that of the second inner peripheral surface 184. However, the inclined angle of the first inner peripheral surface 174 is not necessarily larger than that of the second inner peripheral surface 184. For example, an inclined angle of the first inner peripheral surface 174 may also be smaller than that of the second inner peripheral surface 184.

The lens module 100 configured as described above may be advantageous for decreasing the flare phenomenon due to the space maintaining member 160.

Next, a lens module according to another exemplary embodiment of the present disclosure will be described with reference to FIG. 12. For reference, it is to be noted that a lens module 100 according to the present exemplary embodiment may include at least one of features described in exemplary embodiments of the present disclosure described above.

The lens module 100 according to the present exemplary embodiment is different in a coupling structure between a fifth lens 150 and a lens barrel 200 from the lens module according to exemplary embodiments of the present disclosure described above. For example, the fifth lens 150 may include a plurality of coupling protrusions 158, and the lens barrel 200 may include a plurality of coupling grooves 214 coupled to the protrusions 158, respectively.

In the lens module 100 configured as described above, coupling force between the lens barrel 200 and the fifth lens 150 may be increased, which may be advantageous for excluding the use of a press-fitting member or decreasing an amount of a used adhesive.

Meanwhile, although the case in which the coupling protrusions 158 are formed at the fifth lens 150 has been shown in FIG. 12, the coupling protrusions 158 are not limited to being formed at the fifth lens 150. For example, in the case in which the lens module 100 includes four lenses, the coupling protrusions may be formed at the fourth lens.

As set forth above, according to exemplary embodiments of the present disclosure, the lenses may be easily aligned and the flare phenomenon may be effectively decreased.

While exemplary embodiments have been shown and described above, it will be apparent to those skilled in the art that modifications and variations could be made without deportioning from the spirit and scope of the present disclosure as defined by the appended claims.

What is claimed is:

1. A lens module comprising:
a first lens having a first coupling portion;
a second lens having a second coupling portion; and
a space maintaining member disposed between the first and second lenses and having third and fourth coupling portions coupled to the first and second coupling portions, respectively.

2. The lens module of claim 1, wherein the first coupling portion has a conical sectional surface having a first angle, inclined with respect to an optical axis, and
the third coupling portion has a conical sectional surface having a third angle, inclined with respect to the optical axis.

3. The lens module of claim 2, wherein the first and third inclined angles are the same as or different from each other.

4. The lens module of claim 1, wherein the second coupling portion has a conical sectional surface having a second angle, inclined with respect to an optical axis, and
the fourth coupling portion has a conical sectional surface having a fourth angle, inclined with respect to the optical axis.

5. The lens module of claim 4, wherein the second and fourth inclined angles are the same as or different from each other.

6. The lens module of claim 1, wherein the first coupling portion is a hemispherical groove having a first radius, and
the third coupling portion is a hemispherical protrusion having a third radius.

7. The lens module of claim 6, wherein the first and third radii are the same as or different from each other.

8. The lens module of claim 1, wherein the second coupling portion is a hemispherical groove having a second radius, and
the fourth coupling portion is a hemispherical protrusion having a fourth radius.

9. The lens module of claim 8, wherein the second and fourth radii are the same as or different from each other.

10. The lens module of claim 1, wherein an inner peripheral surface of the space maintaining member is formed as a conical sectional surface having an inclined angle with respect to an optical axis.

11. The lens module of claim 1, wherein an inner peripheral surface of the space maintaining member is formed of a plurality of conical sectional surfaces having different inclined angles with respect to an optical axis.

12. The lens module of claim 1, wherein the space maintaining member is formed of a plurality of members including holes having different sizes.

13. The lens module of claim 12, wherein the space maintaining member includes:
a first space maintaining member including a first hole having a minimum diameter corresponding to a first size and a first inner peripheral surface having a first angle, inclined with respect to an optical axis; and
a second space maintaining member including a second hole having a minimum diameter corresponding to a second size and a second inner peripheral surface having a second angle, inclined with respect to the optical axis.

14. The lens module of claim 13, wherein the first and second sizes are the same as or different from each other.

15. The lens module of claim 13, wherein the first and second inclined angles are the same as or different from each other.

16. A lens module comprising:
a lens barrel having a lens accommodating portion formed therein;
a first lens mounted in the lens accommodating portion so as to be spaced apart from a side of the lens accommodating portion and having a first coupling portion;
a second lens having a second coupling portion; and
a space maintaining member disposed between the first and second lenses and having third and fourth coupling portions coupled to the first and second coupling portions, respectively.

17. The lens module of claim 16, wherein the second lens is coupled to the lens barrel.

18. The lens module of claim 16, wherein the space maintaining member is mounted in the lens accommodating portion so as to be spaced apart from the side of the lens accommodating portion.

19. The lens module of claim 16, wherein the lens accommodating portion has one or more grooves formed in the side thereof, and
the second lens has protrusions formed so as to be coupled to the grooves, the number of protrusions being the same as that of grooves.

20. The lens module of claim 16, further comprising a press-fitting member fixing the second lens to the lens barrel so as to prevent the second lens from being separated from the lens barrel.
